(19) United States
(12) Patent Application Publication
(10) Pub. No.: US 2021/0179435 A1
(43) Pub. Date: Jun. 17, 2021

(54) ACTIVATED CARBON AND METHOD FOR MANUFACTURING SAME

(71) Applicant: TOKAI CARBON KOREA CO., LTD, Gyeonggi-d (KR)

(72) Inventor: Chang Wook SEOL, Gyeonggi-do (KR)

(73) Assignee: TOKAI CARBON KOREA CO., LTD, Gyeonggi-do (KR)

(21) Appl. No.: 17/269,306

(22) PCT Filed: Sep. 13, 2018
(86) PCT No.: PCT/KR2018/010720

§ 371 Date: Feb. 18, 2021

(30) Foreign Application Priority Data
Aug. 31, 2018 (KR) 10-2018-0103710

(51) Int. Cl. C01B 32/348

(52) U.S. Cl. CPC C01B 32/348; C01P 2006/14; C01B 32/384; C01P 2004/61; C01P 2004/10; C01P 2006/16

(57) ABSTRACT

The present invention relates to an activated carbon and a method for manufacturing same and, more specifically, to: an activated carbon containing micropores and mesopores, wherein a micropore volume per unit mass is 0.9 cm³/g or less and a volume fraction of pores having a diameter of 5 Å or more in the micropore volume per unit mass is 50% or more; and a method for manufacturing same.

### TECHNICAL FIELD

The following description relates to an activated carbon and a method for manufacturing the same.

### BACKGROUND ART

In general, activated carbons, which are manufactured by activating the carbonized carbon materials into a porous structure after carbonizing (firing) carbon materials at a temperature of 500° C. or more, show adsorption properties with respect to a solute in liquid or gas, and the surface of activated carbons consists of a network of microscopic pores for adsorption. As these activated carbons have large specific surface areas and uniform particle sizes, the activated carbons have been applied as filters for gas phase adsorption and liquid phase adsorption, or have been usefully used for electrodes in electric double-layer capacitors (EDLC).

A lot of research for investigating a correlation between a pore structure of activated carbon. i.e., an electrode material of the EDLC and electrochemical properties of activated carbon have been made for the development of technology for activated carbon electrodes. According to research results, it is generally known that as the specific surface area is increased, the charging capacity is also increased. Further, it has been reported that when a certain extent or more of the specific surface area is secured, an increase in the fraction of mesopores significantly affects the charging capacity. Accordingly, various studies on the technology of manufacturing activated carbon which improves capacitance have recently been conducted through a method of securing the fraction of the mesopores while maximally increasing the specific surface area of activated carbon. Due to characteristics of activating alkali using carbon with low crystallinity, the technology to secure capacitance by expanding the specific surface area only has reached the limit of the capacitance of the activated carbon that can be improved, and demand for electrodes with higher capacitance continues to exist.

Therefore, there is a growing need for technology to approach in a new way to expand the improvement of capacitance, and furthermore, it is necessary to supply activated carbon, which is not limited to electrode materials but can be applied in many applications.

### DISCLOSURE OF INVENTION

### Technical Subject

An object of the present invention relates to an activated carbon having improved performance by increasing an effective pore ratio enabling ion supporting, as a technology which has been developed to respond to the aforementioned demands.

The present invention relates to a method for manufacturing activated carbon according to the present invention, the method capable of increasing the effective pore ratio enabling ion supporting by adjusting activation process conditions.

Objects to be solved by the present invention are not limited to the above-mentioned object, and other objects that are not mentioned may be clearly understood by those skilled in the art in the following description.

### Technical Solution

According to an aspect of the present invention, there is provided an activated carbon including micropores and mesopores, in which the activated carbon may have a micropore volume per unit mass of 0.9 cm³/g or less and a volume fraction of pores having a diameter of 5 Å or more in the micropore volume per unit mass of 50% or more.

According to an example embodiment of the present invention, the activated carbon may have a mesopore volume per unit mass of 0.1 cm³/g or more.

According to an example embodiment of the present invention, the activated carbon may have a mesopore volume per unit mass of 0.13 cm³/g or more.

According to an example embodiment of the present invention, the activated carbon may have a volume fraction of pores having a diameter of 30 Å or less in the mesopore volume per unit mass of 60% or more.

According to an example embodiment of the present invention, the activated carbon may have a specific surface area (BET) of 500 m²/g to 4,200 m²/g.

According to an example embodiment of the present invention, the activated carbon may have a volume ratio of micropores to the total pores of 0.65 to 0.95.

According to an example embodiment of the present invention, the activated carbon may have a shape of at least one of a tube, a rod, a wire, a sheet, a fiber, and a particle.

According to an example embodiment of the present invention, the activated carbon may be activated and manufactured under the conditions according to the following Equation 1:

6<σ<9 [Equation 1]

σ=0.05 T+M+0.25 H (herein, T: activation temperature (° C.), M: weight of an activation agent/weight of a carbon material (g), H: holding time (hr))

According to an example embodiment of the present invention, a ratio of the micropore volume to the mesopore volume may be 1:1 to 0.1.

According to another aspect of the present invention, there is provided a method for manufacturing activated carbon, the method including the steps for: preparing a carbon material; carbonizing the carbon material; and activating the carbonized carbon material, in which the step for activating is executing the activation process under the conditions according to the following Equation 1:

6<σ<9 [Equation 1]

σ=0.05 T+M+0.25 H (herein, T: activation temperature (° C.), M: weight of an activation agent/weight of a carbon material (g), H: holding time (hr))

According to an example embodiment of the present invention, the step for activating may include the steps for: mixing the carbonized carbon material with an activation agent; and heat-treating the carbonized carbon material that has been mixed with the activation agent.

According to an example embodiment of the present invention, the activation agent is alkali hydroxide, and the activation agent may be injected at a weight ratio of 1 to 5 with respect to the carbon material.

According to an example embodiment of the present invention, in the step for mixing the carbonized carbon material with an activation agent, a mixing ratio of KOH to remaining alkali hydroxide in the activation agent may be 1:0.1 to 1 (w/w).

According to an example embodiment of the present invention, the step for heat-treating may be executing the heat treatment process at an activation temperature of 500° C. to 1,200° C.

According to an example embodiment of the present invention, the activation agent may be contained in an amount of 50 ppm or less in an activated carbon material obtained after performing the step for activating the carbonized carbon material.

According to an example embodiment of the present invention, the method may further include a step for milling the carbonized carbon material to an average size of 3 μm to 20 μm after performing the step for carbonizing.

According to an example embodiment of the present invention, the method may further include a step for executing a washing process after performing the step for activating, and the step for executing a washing process may be performed by one or more methods selected from the group consisting of acid washing, distilled water washing, and inert gas washing.

According to an example embodiment of the present invention, the activated carbon may have a pH value of 6.5 to 7.5 after performing the step for executing a washing process.

According to an aspect of the present invention, the activated carbon may include micropores and mesopores, and may have a micropore volume per unit mass of 0.9 cm³/g or less and a volume fraction of pores having a diameter of 5 Å or more in the micropore volume per unit mass of 50% or more.

According to an example embodiment of the present invention, the activated carbon may have a mesopore volume per unit mass of 0.13 cm³/g or more and a volume fraction of pores having a diameter of 30 Å or less in the mesopore volume per unit mass of 60% or more.

### Effects of the Invention

The present invention may provide an activated carbon which not only provides adsorption performance such as metal ions, harmful substances, and gases, but also can improve performance such as capacitance during application of the activated carbon to an electrode material by increasing the ratio of pores having an effective pore range enabling ion supporting, e.g., a diameter of 5 Å to 30 Å.

The present invention may provide a multi-purpose activated carbon that may be applied as an adsorbent of filer, a carrier of the adsorbent, etc. as well as an electrode applicable to a supercapacitor.

The present invention may provide a method for manufacturing an activated carbon having an increased ratio of effective pores by changing mixing ratio, time and temperature conditions of an activation agent and a carbon material in the activation process.

### BRIEF DESCRIPTION OF DRAWINGS

FIG. 1 shows a process flow chart of a method for manufacturing an activated carbon according to the present invention, according to an example embodiment of the present invention.

FIG. 2 shows the distribution of micropore volumes by the change of conditions according to Equation 1, according to an example embodiment of the present invention.

FIG. 3 shows the distribution of mesopore volumes by the change of conditions according to Equation 1 by the change of conditions according to Equation 1, according to an example embodiment of the present invention.

### BEST MODE FOR CARRYING OUT THE INVENTION

Hereinafter, example embodiments will be described in detail with reference to the accompanying drawings. However, since various changes may be applied to the example embodiments, the scope of the patent application is not restricted or limited by such example embodiments. All the modifications, equivalents, and replacements for the example embodiments should be understood to be included in the scope of the patent application.

Terms used in the example embodiments have been used for the purpose of explanation only, and the terms should not be interpreted as an intention of limiting the explanation. An expression of the singular number includes an expression of the plural number unless clearly defined otherwise in the context. In the present specification, it should be understood that a term such as “comprises” or “having” is used to specify existence of a feature, a number, a step, an operation, a constituent element, a part, or a combination thereof described in the specification, but it does not preclude the possibility of the existence or addition of one or more other features, numbers, steps, operations, constituent elements, parts, or combinations thereof.

Unless otherwise defined, all terms, including technical and scientific terms, used herein have the same meaning as commonly understood by one of ordinary skill in the art to which example embodiments pertain. Terms, such as those defined in commonly used dictionaries, should be interpreted as having meanings that are consistent with those in the context of the related art but are not interpreted as having ideal or excessively formal meanings unless clearly defined in the present application.

Further, in describing the present invention with reference to the accompanying drawings, like elements will be referenced by like reference numerals or signs regardless of the drawing numbers, and description thereof will not be repeated. In describing example embodiments, when it is determined that detailed description of related known techniques unnecessarily obscures the gist of the example embodiments, the detailed description thereof will be omitted.

The present invention relates to activated carbon, and the activated carbon according to an example embodiment of the present invention may improve electrochemical performance and exhibit stable characteristics by including micropores and mesopores and adjusting the ratio of effective pores enabling ion supporting inside the pores.

This adjustment of the ratio of the effective pores may be achieved by adjusting process conditions such as mixture ratio, temperature, and time of an activation agent in the activation process during the manufacturing process of activated carbon, and will be mentioned more specifically in the manufacturing method below. In the present invention, the effective pores mean pores which have a diameter greater than the size of ions and enable ion supporting.

The micropores may have an average size (or diameter) of: 1 Å or more; 1 Å to 20 Å; 1 Å to 17 Å; or 3 Å to 15 Å. The micropore volume is a micropore volume per unit mass (cm³/g) of the activated carbon, and the activated carbon may have a micropore volume per unit mass of: 0.9 cm³/g or less; 0.8 cm³/g or less; or 0.1 cm³/g to 0.8 cm³/g.

When the volume of the micropores is within the micropore volume range, the development of specific surface area is well accomplished and the fraction of the effective pores may be improved. The volume ratio of the micropores to the total pores may be 0.65 to 0.95. The volume ratio of the total pores means the sum of the micropore volume and mesopore volume.

Pores having a size of 5 Å or more in the micropore volume may have a volume fraction of 50% or more. This may improve adsorption performance, allow immobilization, supporting or impregnation of various active materials to be well performed, and improve performance such as capacitance when applied to electrodes by increasing the ratio of effective pores enabling ions to be supported.

The mesopores may have an average size (or diameter) of: 15 Å or more; 20 Å or more; 20 Å to 60 Å; 20 Å to 50 Å; or 25 Å to 45 Å. The mesopore volume is a mesopore volume per unit mass (cm³/g) of the activated carbon, and the activated carbon may have a mesopore volume per unit mass of: 0.1 cm³/g or more; 0.13 cm³/g or more; or 0.1 cm³/g to 0.5 cm³/g. When the volume of the mesopores is within the mesopore volume range, the development of the specific surface area is well accomplished, high capacitance is implemented, or adsorption performance may be improved.

Pores having a size of 30 Å or less in the mesopore volume may have a volume fraction of 60% or more. This may expand capacitance and provide expression of stable performance by preventing large pores within the mesopore range from growing or the ratio of the large pores from increasing while increasing the ratio of effective pores enabling ions in an electrolyte to be supported. In addition, this may provide adsorbent functions of improving adsorption performance and allowing immobilization, supporting or impregnation of various active materials to be well performed by the development of effective pores enabling ions to be supported.

According to an example embodiment of the present invention, the activated carbon may have a shape of at least one of a tube, a rod, a wire, a sheet, a fiber, and a particle.

According to an example embodiment of the present invention, the activated carbon may have a specific surface area (BET) of 500 m²/g to 4,200 m²/g, 500 m²/g to 2,500 m²/g, 1,000 m²/g to 2,500 m²/g, 2,500 m²/g to 4,200 m²/g, or 3,000 m²/g to 4,200 m²/g.

According to an example embodiment of the present invention, the activated carbon may have a pH value of 6.5 to 7.5, and the activation agent may have a concentration of: 50 ppm or less; or 30 ppm or less.

According to an example embodiment of the present invention, the activated carbon may be applied as an electrode material, an adsorbent with adsorption function, or the like. The electrode material may be applied as an electrode material in an energy storage device, and may be applied to, for example, a supercapacitor, an electric double-layer capacitor (EDLC), a secondary battery, etc. That is, an activated carbon according to the present invention may improve capacitance or the like by developing effective pores enabling ions in an electrolyte to be supported.

The adsorbent is intended to adsorb a liquid phase material, a gas phase material, or both materials thereof, and an activated carbon according to the present invention may have an adsorption function, or may be applied as a support in which an active material with the adsorption function is immobilized, supported or precipitated. Namely, adsorption performance of an adsorption target may be improved by developing effective pores enabling ions to be supported in a liquid phase or a gas phase environment, or adsorption performance may be improved by increasing the amount of immobilization, supporting or precipitating of the active material.

The present invention relates to an energy storage device including an activated carbon according to the present invention.

The energy storage device according to the present invention may include: at least one electrode including a housing and an activated carbon according to an example embodiment of the present invention; a separator; and an electrolyte.

The activated carbon applied to the energy storage device may have a specific surface area (BET) of 500 m²/g to 2,500 m²/g.

The energy storage device may have a capacitance of 18 F/cc to 35 F/cc, and the energy storage device may be a capacitor, a lithium secondary battery, or the like.

The present invention relates to an adsorbent including an activated carbon according to the present invention, and a filter including the adsorbent.

The adsorbent and filter may be used in the adsorption of: halogen ions such as chlorine (Cl), fluorine (F), bromine (Br), iodine (I), and the like in a liquid phase, a gas phase, or both thereof; metal ions such as a precious metal, a transition metal, a heavy metal, or the like; organic compounds such as volatile organic compounds (VOCs) or the like; harmful gases such as acidic gases or the like; and others.

The filter may be a porous filtration matrix to which the adsorbent is connected, or the adsorbent coupled onto a porous substrate (for example, a sheet, a film, or the like).

For example, the activated carbon applied to the adsorbent and the filter may have a specific surface area (BET) of 2,500 m²/g to 4,200 m²/g.

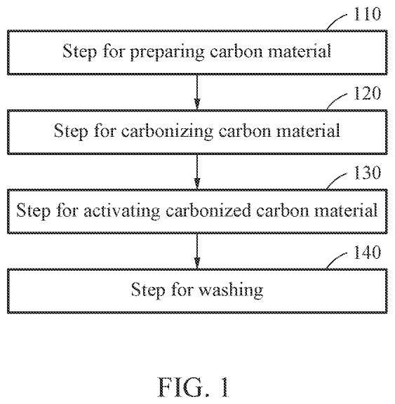

The present invention relates to a method for manufacturing an activated carbon according to the present invention, and will be described in accordance with an example embodiment of the present invention by referring to FIG. 1. FIG. 1 exemplarily shows a flow chart of a method for manufacturing an activated carbon according to the present invention, according to an example embodiment of the present invention, and the manufacturing method in FIG. 1 may include: a step 110 for preparing a carbon material; a step 120 for carbonizing the carbon material; a step 130 for activating the carbonized carbon material; and a step 140 for executing a washing process.

The step 110 for preparing a carbon material is a step for preparing a carbon material that can be used as a main material for the activated carbon. For example, the carbon material may include at least one selected from the group consisting of pitch, coke, isotropic carbon, anisotropic carbon, graphitizable carbon, and non-graphitizable carbon.

The step 120 for carbonizing the carbon material is a step for removing elements and/or impurities except for a carbon component from the carbon material at high temperatures in order to increase crystallinity, performance, quality (for example, purity), and the like of the activated carbon.

In the step 120 for carbonizing the carbon material, components other than the carbon component may be evaporated in the form of oil vapor. Although it may depend on original components when the carbonation process is completed, a carbonized carbon material with a weight reduction of approximately 3% to 40% compared to a prepared carbon material may be acquired.

In the step 120 for carbonizing the carbon material, a carbonization temperature may be a temperature ranging from 500° C. to 1,200° C. When the carbonization temperature is within the temperature range, an activated carbon which has a high XRD, a maximum peak intensity and a high crystallinity, and is capable of being applied as an electrode, an adsorbent or the like of an energy storage device may be provided.

The step 120 for carbonizing the carbon material may be performed in an atmosphere of at least one of air, oxygen, carbon and an inert gas for 10 minutes to 24 hours. For example, the inert gas may be an argon gas, a helium gas, a hydrogen gas, a nitrogen gas, or the like.

According to an example embodiment of the present invention, the method may further include a step for milling the carbonized carbon material (not shown in the drawing) after the step 120 for carbonizing the carbon material. For example, the step for milling may powder the carbon material by milling the carbon material that has been carbonized to an average particle size of 3 μm to 20 μm. If the carbon material is within the particle size range, an activation agent may be well adsorbed on the surface of the carbon materials and the activation area of the carbon material may be increased.

The step for milling the carbonized carbon material may be performed using mechanical milling, and the mechanical milling may include one or more selected from the group consisting of rotor mill, mortar milling, ball milling, planetary ball milling, jet milling, bead milling, and attrition milling.

The step 130 for activating the carbonized carbon material may include: a step 131 for mixing the carbonized carbon material with the activation agent; and a step 132 for heat-treating the carbonized carbon material that has been mixed with the activation agent.

The step 130 for activating the carbonized carbon material may carry out the activation process under the process conditions according to Equation 1 below by adjusting at least one of mixing ratio, temperature and time of the activation agent in the activation process. If a σ value is within the range in the Equation 1, the ratio of effective pores for ion supporting within the micropores and mesopores may be increased, and enlargement of the pore size due to an increase in the a value may be prevented.

6<σ<9 [Equation 1]

σ=0.05 T+M+0.25 H

Here, T is an activation temperature (° C.), M is weight of an activation agent/weight of a carbon material (g/g), and H is a holding time (hr).

The step 131 for mixing the carbonized carbon material with the activation agent is a step for mixing the carbonized carbon material with the activation agent in the step 120 for carbonizing the carbon material.

The activation agent may be injected at a weight ratio of 1 to 5 with respect to the carbonized carbon material. If the activation agent is injected within the weight ratio range, an activated carbon which increases the development of the specific surface area of the activated carbon and improves performance such as capacitance may be provided.

The activation agent is alkali hydroxide, and may be, for example, MOH (M=an alkali metal of Li, Na, K or Cs). Preferably, the activation agent may be KOH, NaOH, or the like.

The alkali hydroxide may be injected in the form of a mixture to improve the specific surface area by adjusting the ratio of the micropores to the mesopores of the activated carbon in the activation process, and a mixing ratio of one alkali hydroxide to the other alkali hydroxide may be, for example, 1:0.1 to 1 (w/w). Preferably, a mixing ratio of one alkali hydroxide with a high reactivity to the other alkali hydroxide with a relatively low reactivity may be 1:0.1 to 1 (w/w). If the alkali hydroxide is injected within the mixing ratio range, the ratio of the micropores to the mesopores and the ratio of effective pores may be easily adjusted depending on activation process conditions such as temperature.

The step 132 for heat-treating the carbonized carbon material that has been mixed with the activation agent is a step for heating a mixture of the carbonized carbon material and the activation agent (or, executing a heat treatment process), thereby decomposing the activation agent and activating the surface of the carbonized carbon material to form an activated carbon material (or activated carbon).

A step 131 for activating the carbonized carbon material that has been mixed with the activation agent may include executing an activation process at an activation temperature of: 500° C. or more; or 500° C. to 1,000° C., and may enlarge the ratio of effective pores by adjusting the activation temperature according to Equation 1. If the activation temperature is within the activation temperature range, an activated carbon which has a large specific surface area, allows micropores to be formed well, prevents an increase in the particle size due to agglomeration or the like of the activated carbon, and has excellent crystallinity may be provided.

The step 131 for activating the carbonized carbon material that has been mixed with the activation agent may be performed for 10 minutes to 24 hours, and the activation time may be adjusted according to Equation 1 to enable the ratio of effective pores to be enlarged. If the activation time is within the time range, the activation process is sufficiently carried out, and agglomeration or the like between activated carbons due to prolonged exposure at high temperatures may be prevented.

The step 131 for activating the carbonized carbon material that has been mixed with the activation agent may be performed in an atmosphere containing at least one of air, oxygen, and an inert gas. For example, the inert gas may be an argon gas, a helium gas, hydrogen, nitrogen, or the like.

According to an example embodiment of the present invention, the method may further include a step for milling the activated carbon (not shown in the drawing) after the step 131 for activating the carbonized carbon material that has been mixed with the activation agent, and, for example, the step for milling the activated carbon may powder the activated carbon into fine particles by milling the activated carbon to an average particle size of 3 μm to 20 μm.

The step 140 for executing a washing process is a step for washing an activated carbon obtained after the step 131 for activating the carbonized carbon material that has been mixed with the activation agent.

The step 140 for executing the washing process may be performed by one or more methods selected from the group consisting of acid washing, distilled water washing, and inert gas washing. For example, an acid solution including an inorganic acid, an organic acid, or both thereof may be applied to the acid washing, and, for example, an acidic aqueous solution including one or more selected from the group consisting of sulfuric acid, hydrochloric acid, nitric acid, acetic acid, formic acid, and phosphoric acid may be applied to the acid washing.

According to an example embodiment of the present invention, the method may further include a step for executing a drying process (not shown in the drawing) after the step 140 for executing the washing process. For example, the step for executing the drying process may include drying the washed activated carbon material at a temperature of 50° C. to 200° C. for 10 minutes or more; or 10 minutes to 40 hours, and drying the washed activated carbon material under vacuum; or in an atmosphere of air, an inert gas or both thereof.

According to an example embodiment of the present invention, the activated carbon material manufactured by the method may have a pH value of 6.5 to 7.5, and a concentration of the activation agent of 50 ppm or less; or 30 ppm or less. The pH value and concentration of the activation agent may be numerical values obtained after executing the washing process, the drying process, or both thereof.

According to an example embodiment of the present invention, there is a step for heat-treating the activated carbon material to remove impurities and the like after the step for executing the drying process. For example, metal impurities, an oxygen functional group, and the like may be removed.

The heat treatment process may be carried out at a temperature of 300° C. or more; 300° C. to 1,000° C.; or 500° C. to 1,000° C. for 10 minutes or more; or 10 minutes to 40 hours. If the heat treatment process is carried out within the temperature and time ranges, the oxygen content (oxygen functional group) and metal impurities in the activated carbon may be well removed, and the reduction of the specific surface area or the like may be prevented. The heat treatment process may be conducted in a hat treatment atmosphere containing a chlorine-containing gas, an inert gas, or both thereof, and the chlorine-containing gas may be contained in an amount of 1% to 50% (v/v); 5% to 50% (v/v); 5% to 40% (v/v); or 10% to 30% (v/v) in a gas forming the atmosphere. If the chlorine-containing gas is contained in the amount range, reduction of the specific surface area may be lowered, and removal efficiency of metal impurities or the like caused by chlorine may be increased by preventing the destruction of a pore structure due to hydrogen gas, etc.

### Examples 1 to 5

Carbides formed by carbonizing petroleum-based coke materials for 10 hours were obtained. According to values of Equation 1 shown in Table 1, the carbides and activation agent (KOH:NaOH=1:1 (w/w)) were mixed at a mass ratio of 1:1 to 1:5 in a mixer. Next, after injecting mixtures into a crucible, the mixtures were activated in an inert atmosphere at a temperature of 600° C. to 1,000° C. for 10 to 12 hours. Next, after repeatedly cleaning and washing the activated mixtures three times using an aqueous hydrochloric acid solution, the cleaned and washed activated carbons were dried. Activated carbons were obtained by passing the dried activated carbons through a sieve.

### Comparative Examples 2 to 4

Activated carbons were obtained in the same manner as in Example 1 except that the activation process was adjusted according to values of Equation 1 shown in Table 1.

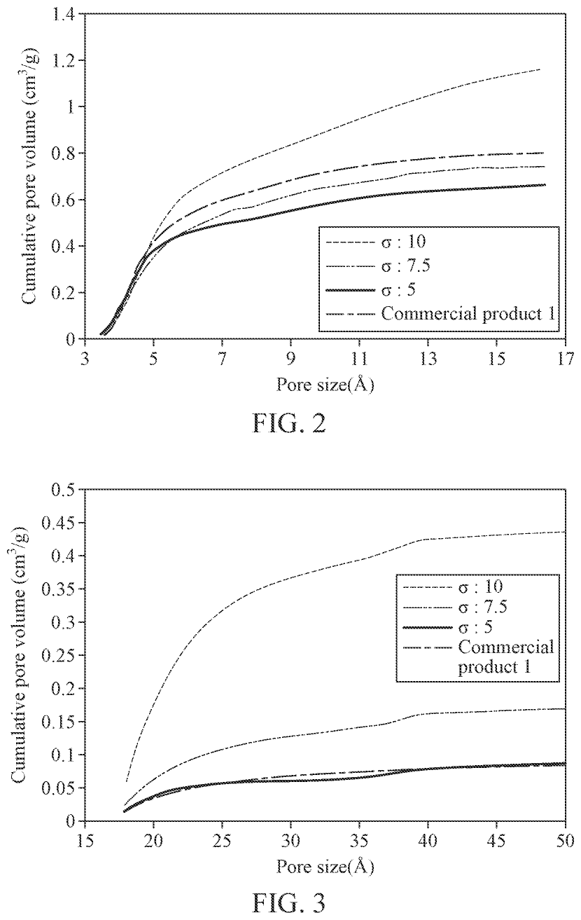

After measuring BET values and pore volumes of the activated carbons manufactured in Examples and Comparative Examples, the measured BET values and pore volumes of the activated carbons are shown in Table 1 and FIGS. 2 and 3. In the pore volumes, micropore volumes were measured by Horvath-Kawazoe (HK) method, and mesopore volumes were measured by Barrett-Joyner-Halenda (BJH) method. In addition, after measuring capacitances of the activated carbons, the measured capacitances of the activated carbons are shown in Table 1.

TABLE 1

| | | | | | | Com. | Com. | Com. | Com. |
|---|---|---|---|---|---|---|---|---|---|
| Composition | Ex. 1 | Ex. 2 | Ex. 3 | Ex. 4 | Ex. 5 | Ex. 1 | Ex. 2 | Ex. 3 | Ex. 4 |
| σ | 6.1 | 6.3 | 6.8 | 7.5 | 8.05 | — | 5 | 9.5 | 10 |
| Specific | 1,560 | 1,713 | 1,796 | 1,922 | 2,135 | 2,001 | 1,450 | 2,345 | 2,813 |
| surface area | | | | | | | | | |
| (m\hat{ }2/g) | | | | | | | | | |
| Micropore | 0.658 | 0.717 | 0.856 | 0.734 | 0.867 | 0.801 | 0.661 | 1.039 | 1.160 |
| Volume | | | | | | | | | |
| (cm\hat{ }3/g) | | | | | | | | | |
| <5 Å (cm\hat{ }3/g) | 0.328 | 0.334 | 0.431 | 0.323 | 0.412 | 0.407 | 0.369 | 0.374 | 0.433 |
| >5 Å (cm\hat{ }3/g) | 0.330 | 0.383 | 0.456 | 0.411 | 0.449 | 0.395 | 0.322 | 0.665 | 0.727 |
| Ratio (>5 Å | 50% | 53% | 53% | 56% | 52% | 49% | 49% | 64% | 63% |
| Vol./Micropore | | | | | | | | | |
| Vol.) | | | | | | | | | |
| Mesopore | 0.119 | 0.181 | 0.189 | 0.190 | 0.163 | 0.120 | 0.111 | 0.374 | 0.470 |
| Volume | | | | | | | | | |
| (cm\hat{ }3/g) | | | | | | | | | |
| <30 Å (cm\hat{ }3/g) | 0.060 | 0.110 | 0.115 | 0.128 | 0.107 | 0.065 | 0.060 | 0.273 | 0.358 |
| >30 Å (cm\hat{ }3/g) | 0.059 | 0.071 | 0.074 | 0.062 | 0.056 | 0.055 | 0.051 | 0.101 | 0.112 |
| Ratio (<30 Å | 50% | 61% | 61% | 67% | 66% | 54% | 54% | 73% | 76% |
| Vol./Mesopore | | | | | | | | | |
| Vol.) | | | | | | | | | |
| Capacitance* | 1.03 | 1.15 | 1.16 | 1.18 | 1.19 | 1 | 0.93 | 0.89 | 0.88 |

*Capacitance: values obtained by dividing capacitance values of activated carbons by capacitance value of a commercial product (Comparative Example 1) having pore characteristics of Table 1 (capacitance values of activated carbons of Examples or Comparative Examples/capacitance value of the commercial product)

Referring to Table 1, and FIGS. 2 and 3, it may be checked that a pore ratio of 5 to 30, i.e., effective pores of enabling ion supporting may be increased, and the capacitance values are consequently increased compared to that of the commercial product (Comparative Example 1) in Examples 1 to 4 within activation process conditions according to Equation 1. Particularly, although a micropore volume of Example 4 is lower than those of the commercial product and Comparative Example 4, it may be checked that the capacitance value of Example 4 has been improved significantly compared to the commercial product and Comparative Example 4.

Meanwhile, with regard to Comparative Examples 1 to 4, it may be checked that Comparative Examples 1 and 2 have low ratios of pores having sizes of 5 Å or more, and Comparative Examples 3 and 4 have low capacitance values. As checked in FIGS. 2 and 3, it may be predicted that this reduction in capacitance value particularly in Comparative Example 4 is due to a sharp increase in the micropore volume and the mesopore volume.

Namely, the present invention may provide an activated carbon with significantly improved capacitance compared to an activated carbon with the same or similar specific surface area by adjusting ratio, temperature and time of an activation agent in the activation process, thereby increasing the ratio of effective pores of 5 Å to 30 Å. Furthermore, the present invention may provide an activated carbon which may be applied to an adsorbent, a support, or a filter of various components with improved adsorption performance by using effective pores enabling ion supporting.

Various modifications or changes from the aforementioned descriptions can be made by a person having ordinary skill in the art. For example, appropriate results can be achieved although described techniques are performed in order different from a described method, and/or described elements are joined or combined in a form different from the described method, or replaced or substituted by other elements or equivalents. Therefore, other implementations, other example embodiments, and equivalents of the scope of claims also belong to the scope of the claims described below.

1. An activated carbon comprising micropores and mesopores, wherein the activated carbon has a micropore volume per unit mass of 0.9 cm³/g or less and a volume fraction of pores having a diameter of 5 Å or more in the micropore volume per unit mass of 50% or more.

2. The activated carbon of claim 1, wherein the activated carbon has a mesopore volume per unit mass of 0.1 cm³/g or more.

3. The activated carbon of claim 1, wherein the activated carbon has a mesopore volume per unit mass of 0.13 cm³/g or more.

4. The activated carbon of claim 1, wherein the activated carbon has a volume fraction of pores having a diameter of 30 Å or less in the mesopore volume per unit mass of 60% or more.

5. The activated carbon of claim 1, wherein the activated carbon has a specific surface area (BET) of 500 m²/g to 4,200 m²/g.

6. The activated carbon of claim 1, wherein the activated carbon has a volume ratio of micropores to the total pores of 0.65 to 0.95.

7. The activated carbon of claim 1, wherein the activated carbon has a shape of at least one of a tube, a rod, a wire, a sheet, a fiber, and a particle.

8. The activated carbon of claim 1, wherein the activated carbon is activated and manufactured under conditions according to the following Equation 1:
6<σ<9 [Equation 1]
σ=0.05 T+M+0.25 H (herein, T: activation temperature (° C.), M: weight of an activation agent/weight of a carbon material (g), H: holding time (hr)).

9. A method for manufacturing an activated carbon, the method comprising:
preparing a carbon material;
carbonizing the carbon material; and
activating the carbonized carbon material,
wherein the activating is executing the activation process under conditions according to the following Equation 1:
6<σ<9 [Equation 1]
σ=0.05 T+M+0.25 H (herein, T: activation temperature (° C.), M: weight of an activation agent/weight of a carbon material (g), H: holding time (hr)).

10. The method of claim 9, wherein the activating comprises:
mixing the carbonized carbon material with the activation agent; and
heat-treating the carbonized carbon material that has been mixed with the activation agent.

11. The method of claim 9, wherein the activation agent is alkali hydroxide, and the activation agent is injected at a weight ratio of 1 to 5 with respect to the carbon material.

12. The method of claim 11, wherein, in the mixing of the carbonized carbon material with the activation agent, a mixing ratio of KOH to remaining alkali hydroxide in the activation agent is 1:0.1 to 1 (w/w).

13. The method of claim 10, wherein the heat-treating is executing the heat treatment process at an activation temperature of 500° C. to 1,200° C.

14. The method of claim 9, wherein the activation agent is contained in an amount of 50 ppm or less in an activated carbon material obtained after the activating of the carbonized carbon material.

15. The method of claim 9, further comprising, after the carbonizing:
milling the carbonized carbon material to an average size of 3 μm to 20 μm.

16. The method of claim 9, further comprising, after the activating:
performing washing,
wherein the washing is performed by one or more methods selected from the group consisting of acid washing, distilled water washing, and inert gas washing.

17. The method of claim 16, wherein the activated carbon has a pH value of 6.5 to 7.5 after the performing of the washing.

18. The method of claim 9, wherein the activated carbon comprises micropores and mesopores, and has a micropore volume per unit mass of 0.9 cm³/g or less and a volume fraction of pores having a diameter of 5 Å or more in the micropore volume per unit mass of 50% or more.

19. The method of claim 18, wherein the activated carbon has a mesopore volume per unit mass of 0.13 cm³/g or more and a volume fraction of pores having a diameter of 30 Å or less in the mesopore volume per unit mass of 60% or more.
